(19) United States
(12) Patent Application Publication
(10) Pub. No.: US 2020/0253697 A1
(43) Pub. Date: Aug. 13, 2020

(54) MULTI-FUNCTION DENTAL IMPLANT SYSTEM

(71) Applicant: SPFM, LP, SAN ANTONIO, TX (US)

(72) Inventors: BASIL BATTAH, SAN ANTONIO, TX (US); MAURICE SALMA, ATLANTA, GA (US); DEAN VAFIADIS, NEW YORK, NY (US)

(21) Appl. No.: 16/723,717

(22) Filed: Dec. 20, 2019

Related U.S. Application Data
(60) Provisional application No. 62/782,806, filed on Dec. 20, 2018.

(51) Int. Cl. A61C 8/00; A61C 9/00

(52) U.S. Cl. CPC A61C 8/008; A61C 8/005; A61C 9/0053; A61C 2201/005; A61C 8/0001; A61C 8/0062; A61C 2008/0084; A61C 8/0012

(57) ABSTRACT

An intra-procedure dental implant stabilization and healing system that includes a soft tissue forming scanning abutment and associated, temporary crown. After initial implant placement, a scanning abutment of the present system is attached to the implant and serves, both as a scanning body and, in combination with a temporary crown attached thereto, as a healing cap. Use of the system obviates an additional surgical incision to reach recipient osseointegrated implant, as is required in conventional implant procedures, as well as the need for a conventional impression coping, separate healing cap, temporary abutment and temporary crown.

### STATEMENT OR PRIORITY

The present application claims priority to U.S. Provisional Application No. 62/782,806, titled “Multi-Function Dental Implant System,” which was filed on Dec. 20, 2018.

### BACKGROUND OF THE INVENTION

### Field of the Invention

The present invention relates to dental implant components and methods of implantation and related patient treatment.

### Background of the Invention

The advent of dental implants as a means for addressing tooth loss and related complications represents a significant advance in the dental field's contributions to patient health, comfort and happiness.

Even a single missing tooth can, depending on its position, affect both a person's ability to comfortably chew, as well and their appearance. The latter can have a significant, and well-documented impact on (subjective) self-esteem, and even others (objective) reaction to a person, such as in professional, inter-personal contexts. Perhaps lesser known is that a missing tooth can promote bone loss in the jaw, leading to still further physical and mental health issues, not the least of which can arise from the apparent pre-mature aging of a person whose jaw line has receded because of such loss.

When more than a single tooth is missing, the magnitude of these issues can accumulate in a near exponential manner.

The traditional process of dental implant implantation involves (assuming a tooth is already missing, or has now been extracted) accessing the upper jaw bone (maxilla) or lower jaw bone (mandible) to create an “osteotomy”, or recipient site into which the implant will be inserted.

The implant is, by convention, a titanium body that is exteriorly threaded and is accordingly screwed into pre-formed osteotomy in the receiving bone (maxilla or mandible).

The proximal portion of the implant includes an interface with engagement means for securely engaging an abutment. The abutment is the intermediary body that attaches its lower end, to the already-implanted dental implant. A permanent crown is then attached to the abutment via screw or cement (visible, natural-looking portion of the artificial tooth comprised of the entire implant-abutment assembly).

The complete implant assembly typically is not assembled at-once, but rather involves several intervening phases. By convention this can include: a subsequent incision of the gum to expose the implant/abutment interface to facilitate placement of a “healing cap”, scan body, impression coping, temporary abutment and final abutment. —More specifically, by conventional practice, the implant is placed, as described above, the gum tissue is closed, the implant is left for some weeks to become naturally secured through bone growth (“osseointegration”).

After the passage of prescribed time required for implant stability, the implant is re-accessed and, in place of the later-to-be-attached abutment, and if the practitioner has the systems for digital scanning, a scanning body is attached to the implant(s). The “scanning body” is, as the name implies, used for scanning purposes, and in this case, is used to digitally scan the exact position and shape that the final crown will require to provide the patient with the most favorable replacement “tooth.” Absent digital scanning capability, the practitioner will temporarily attach an impression coping, in lieu of a permanent abutment, just so long as to take a physical, tray-based (open tray or closed tray) impression. After this latter, “analog impression,” the impression coping is removed, a healing cap is installed, the incision is once again closed, and the procedures progresses as follows.

Once scanning, or the taking of physical impressions is complete, by convention, a “healing” cap is attached (or re-attached, as the case may be) to the implant, while awaiting placement of the final prosthetic tooth assembly. The healing cap extends from the implant and above the gum line, and serves to provide a “template” about which the soft tissue grows to properly accommodate and “fit” the ultimate abutment and crown. Only after soft tissue healing is the final abutment and permanent crown attached.

The over-all, conventional dental implant process involves several months, to allow for the various healing processes.

It requires no explanation to suggest that any shortening of the process would be desirable. Better still were the number of surgical accesses to the jaw bone and the soft tissue were to somehow be reduced. Were there, for example, to be means and method by which one could reduce multiple accesses to the jaw bone and soft tissue for placing the impression coping, scan body and/or healing cap, the chances of surgical complications (present with any surgical procedure) could be reduced. This alone would be advantageous. However, were such means and method to further enable, for example, the immediate, after-implant-placement installation of a single component that could itself serve as all of: (1) a scanning body (or implant coping—open tray or closed tray), (2) a healing cap, (3) a temporary abutment and (4) as a foundation for a temporary crown—the over-all implant process could be dramatically shortened and the patient experience made measurably less unpleasant (including by having to undergo fewer procedures, and having a functional, temporary restoration while mid-process). Further still, this would logically have a very beneficial impact on over-all costs to patients and insurance.

### SUMMARY OF THE INVENTION

In view of the foregoing, it would be advantageous to dental patients who are in need of dental implants to provide a means and methods for implant procedures with reduced surgical intervention.

It would be further advantageous at least to dental implant patients, and those financially responsible for services to dental implant patients, to reduce the number or procedures required for dental implant placement.

It would be further advantageous at least to dental implant patients to shorten the duration of over-all dental implant placement and restoration.

The present inventors here disclose a novel and unobvious apparatus and associated method for use in dental implant procedures, which apparatus and method can reasonably be expected to reduce the number of surgical interventions, to reduce the number of steps and reduce the number of product parts needed to complete the dental implant process; reduce the costs associated with dental implant processes, and reduce the over-all duration of the overall dental implant experience.

The apparatus of the present invention is an assembly that serves as a combined scanning body/impression coping (“scanning abutment”), soft tissue forming healing cap, and temporary abutment (hereafter “scanning abutment assembly”). According to the present method, to the scanning abutment assembly of the preferred embodiment is attached a temporary crown to serve as a temporary restoration (prosthetic tooth surface), while awaiting final abutment and permanent crown placement.

The scanning abutment is contoured, depending on the natural tooth's position that the ultimate implant assembly is the occupy, to serve as a healing cap for facilitating appropriate soft tissue re-growth for accommodation of the final, permanent abutment.

The scanning abutment is, in the preferred embodiment, fashioned of PEEK 180 material (PEEK is a polymer—POLYETHERETHERKETONE) that allows it to serve as a traditional scanning body (or impression coping) for digital scanning due to its radiopaque properties, but is also structured for, and suitable for both service as an open tray or closed tray impression coping, as well as a temporary abutment to which a temporary crown may be attached pending healing and fabrication of the final, permanent implant assembly components. In this regard, PEEK 180 is known to be safely left in-place for up to about 6 months.

Because, pending the completion of osteogenesis surrounding the implant, and soft tissue healing, the scanning abutment replaces the functions of a conventional healing cap, as well as a temporary abutment and foundation for a temporary crown until the final abutment and permanent crown may be placed, the scanning abutment obviates the need for at least one surgical accessing of the maxilla and/or mandible for permanent abutment placement. This, because the abutment (serving as a healing cap) already extends from the outset from the implant through the gum line, with soft tissue healing in conformity with, and reading to accept placement of the final abutment.

### BRIEF DESCRIPTION OF THE DRAWINGS

FIG. 1 is a first side elevational view of an embodiment of a scanning abutment of the present invention.

FIG. 2 is a second side elevational view of an embodiment of a scanning abutment of the present invention, rotated axially approximately 90 degrees from the view of FIG. 1.

FIG. 3 is a cross-sectional view of the scanning abutment of FIG. 1, shown along line A-A of FIG. 2.

FIG. 4 is a bottom plan view of the scanning abutment of FIGS. 1 and 2.

FIG. 5 is a top plan view of the scanning abutment of FIGS. 1 and 2.

FIG. 6 is a first elevational view of an embodiment of a temporary crown of the present invention for interfacing with the scanning abutment of FIGS. 1-5.

FIG. 7 a second side elevational view of an embodiment of a temporary crown of the present invention, rotated axially approximately 90 degrees from the view of FIG. 6.

FIG. 8 is a cross-sectional view of the temporary crown of FIGS. 6 and 7, along line B-B of FIG. 7.

FIG. 9 is a top plan view of the temporary crown of FIGS. 6-7.

### DETAILED DESCRIPTION OF THE PREFERRED EMBODIMENT

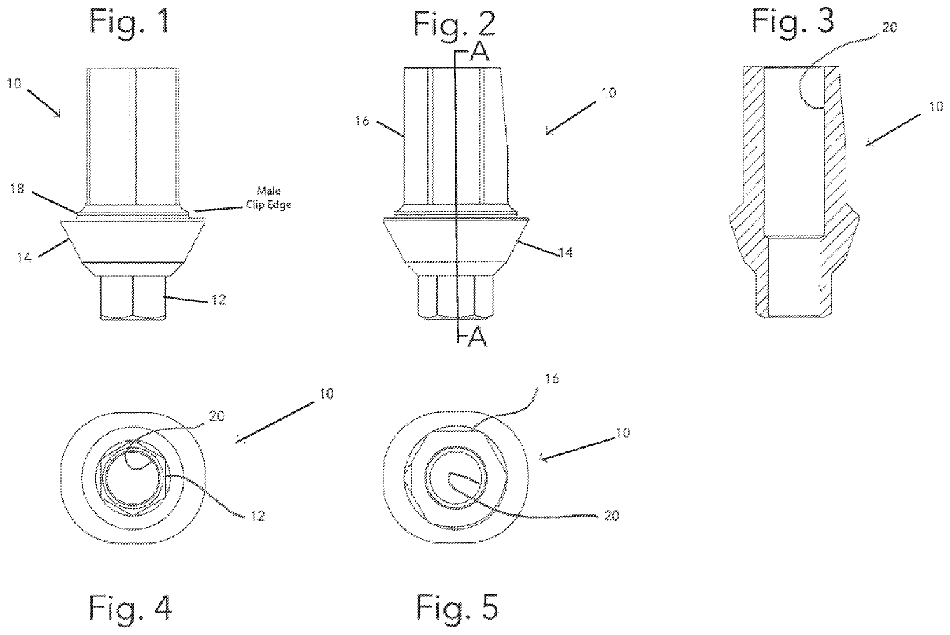

Referring to FIGS. 1-3, a preferred embodiment of a scanning abutment of the present invention is identified generally by the reference numeral 10. Scanning abutment 10 includes an insert interface extension 12 for interfacing, via a male/female, spine-like interface (hexagonal interface, in a preferred embodiment) with a distally residing portion of a proximally-facing lumen of a dental implant (not shown in the drawings). A flange 14 is complimentarily shaped such that, when scanning abutment 10 is fully interfaced with a dental implant, it nests within a complimentarily-shaped and sized, proximal portion of the referenced proximal lumen of the dental implant.

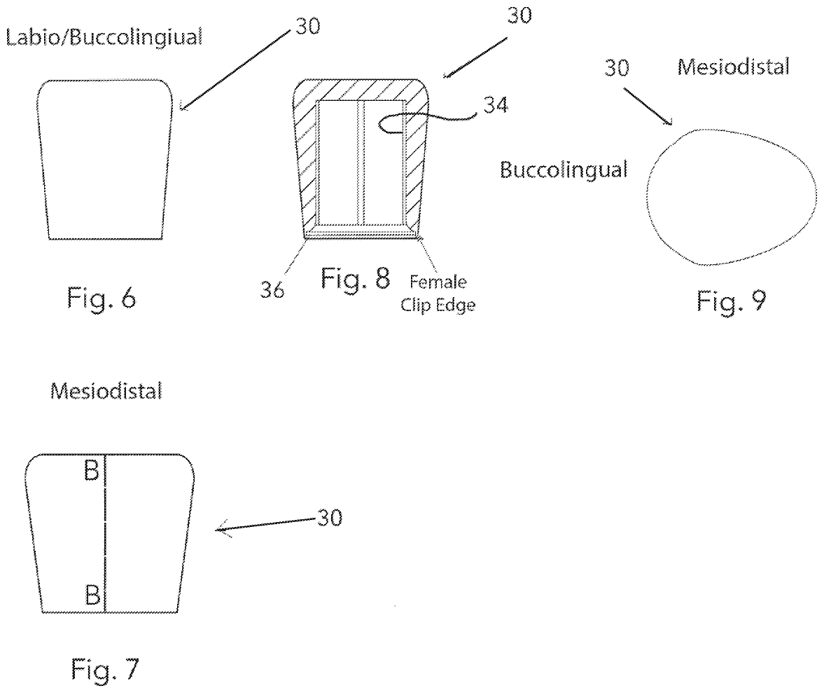

Referring to FIGS. 1-3 and 5, a crown interface shaft 16 extends from the portion of scanning abutment 10 identified as flange 14. Crown interface shaft 16 is primarily, exteriorly hexagonal in a preferred embodiment, and is designed for telescopic reception into a complimentarily-shaped and sized, female lumen 34 of temporary crown 30 (an exemplary embodiment being shown in FIGS. 6-9). Alternatives to the mentioned, complementary hexagonal contouring of the crown interface shaft 16 and lumen 34 of the temporary crown 30 will be apparent to persons skilled in the art, and may include any spline-like interface design for preventing relative, axial rotation between the components.

Whatever the actual, respective, exterior geometric configurations of the crown interface shaft 16 and female lumen 34 of temporary crown 30, it is to be noted that, in a preferred embodiment, the dimensions are not uniform along the respective lengths thereof. Rather, in a first respect, they are respectively adjusted or contoured as needed to accommodate the exterior surface contours of temporary crown 30, and otherwise as may be needed for the present assembly to obviate the need for the conventional healing cap presently used in dental implant procedures. This, because such size and contouring is for mimicking the “footprint” of the natural tooth that the assembly replaces, serving as something of a mold, or guide for the re-growth of soft tissues as they envelope the implant assembly as would occur in surrounding the corresponding, natural tooth. Secondly, a preferred mode of practicing the present method involves a respectively unique contouring of the outer surfaces of each chosen scanning abutment for a particular patient, such that, when the scanning abutments are used for digital scanning, the computer will “recognize” and differentiate individual scanning abutments rather than (as has been reported in the use of some conventional scanning bodies) mistaking a grouping as a single unit).

The transition from crown interface shaft 16 and flange 14 is configured as a circumferential ridge, here to be identified as the male crown clip 18. Male crown clip 18 is configured to reversibly engage with a circumferential recess 36 that is formed within the temporary crown 30 (to be identified, correlated with figures and discussed more fully hereafter).

A central lumen 20 extends centrally/axially along the length of scanning abutment 10, through which attachment means (not shown in the drawings) are passed and manipulated by a practitioner for attaching scanning abutment 10 to an implanted dental implant (not shown in the drawings).

Referring to FIGS. 6-9, designed for interface with scanning abutment 10 is temporary crown 30. As mentioned before, temporary crown 30 includes a central, female lumen 34 that is interiorly hexagonal (but variable in dimensions along its axial length for reasons discussed above) and is otherwise sized and shaped for close, telescopic engagement with crown interface shaft 16 of scanning abutment 10. Also, as mentioned previously, circumferential recess 36 is formed near the opening of lumen 34 for a “snap-on” interface with male crown clip 18. Again, the temporary crown 30 is contoured to exteriorly mimic the natural tooth that is partially replaces, for reasons related to its contribution as a replacement for the conventional healing cap, as well as functioning as a prosthetic tooth during the osteogenesis and other healing processes that precede placement of the permanent abutment and crown (not shown in the drawings).

As mentioned previously, scanning abutment is, in the preferred embodiment, fashioned from a material known in the field as “PEEK”. This material is both sufficiently durable to allow for the term of use needed prior to final attachment of a permanent abutment (not shown in the drawings), as well as having properties suitable for digital scanning purposes as is known in the art.

The advantages arising from substituting conventional apparatus and associated methods with those of practicing the present invention include those described above in the Summary of the Invention portion hereof.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A temporary abutment assembly for use in dental implant procedures in replacing a natural tooth:
an elongate scanning abutment configured of a radiopaque, biocompatible material, said scanning abutment having:
an implant interface portion configured at a distal scanning abutment end, said implant interface portion being configured in dimension and contouring for mechanical interface in a telescopic engagement with a complimentarily sized and shaped lumen of a dental implant and for resisting axial rotation relative to said dental implant,
a flange portion of dimensions and contours for nested juxtaposition between respective surfaces of said flange and a proximal orifice of a dental implant,
a temporary crown interface shaft portion extending from said flange portion and terminating at a proximal scanning abutment end, and
a central lumen passing substantially axially along a central axis;
said temporary crown interface shaft portion of said scanning abutment being configured in complimentary dimensions and contouring for, at least in part, mechanical interface in a male-female engagement with a lumen of a temporary crown and for resisting axial rotation relative to said temporary crown;
a temporary crown having an exterior surface that is sized and contoured to substantially replicate surfaces of a corresponding to-be-replaced said natural tooth that, when said natural tooth is in situ, are surrounded and juxtaposed by adjacent gum tissues;
said temporary crown having a substantially central lumen that is sized and shaped for telescopically receiving therein, and for mechanically registering with said crown interface shaft portion of said scanning abutment for resisting axial rotation of said crown interface shaft portion relative to said temporary crown.

2. A temporary abutment assembly for use in dental implant procedures in replacing first and second natural teeth:
first and second elongate scanning abutments, each configured of a radiopaque, biocompatible material, each of said scanning abutments having:
an implant interface portion configured at a distal scanning abutment end, said implant interface portion being configured in dimension and contouring for mechanical interface in a telescopic engagement with a complimentarily sized and shaped lumen of respective first and second dental implants and for resisting axial rotation relative to said dental implants,
a flange portion of dimensions and contours for nested juxtaposition between respective surfaces of said flange and a proximal orifice of each of respective said dental implants,
a temporary crown interface shaft portion extending from said flange portion and terminating at a proximal scanning abutment end, and
a central lumen passing substantially axially along a central axis;
said temporary crown interface shaft portions of each of said scanning abutments being configured in complimentary dimensions and contouring for, at least in part, mechanical interface in a male-female engagement with a lumen of a temporary crown and for resisting axial rotation relative to said temporary crown, and with said dimensions and contouring of respective said first and second scanning abutments being further physically differentiated relative to each other by the addition or removal of surface projections, protrusions or indentions to one or both of said first and second scanning abutments;
first and second temporary crowns each having an exterior surface that is sized and contoured to substantially replicate surfaces of corresponding to-be-replaced, respective said first and second natural teeth that, when said natural teeth are in situ, are surrounded and juxtaposed by adjacent gum tissues;
said temporary crowns each having a substantially central lumen that are sized and shaped for telescopically receiving therein, and for mechanically registering with said crown interface shaft portions of said first and second scanning abutments for resisting axial rotation of said crown interface shaft portion relative to respective said first and second temporary crowns.

3. A method for providing temporary tooth and healing promotion structures to a dental implant patient comprising the steps of:
selecting a dental implant and a temporary, prosthetic tooth assembly, said prosthetic tooth assembly comprising:
dental implant an elongate scanning abutment configured of a radiopaque, biocompatible material, said scanning abutment having:
an implant interface portion configured at a distal scanning abutment end, said implant interface portion being configured in dimension and contouring for mechanical interface in a telescopic engagement with a complimentarily sized and shaped lumen of a dental implant and for resisting axial rotation relative to said dental implant,
a flange portion of dimensions and contours for nested juxtaposition between respective surfaces of said flange and a proximal orifice of a dental implant,
a temporary crown interface shaft portion extending from said flange portion and terminating at a proximal scanning abutment end, and
a central lumen passing substantially axially along a central axis;
said temporary crown interface shaft portion of said scanning abutment being configured in complimentary dimensions and contouring for, at least in part, mechanical interface in a male-female engagement with a lumen of a temporary crown and for resisting axial rotation relative to said;
a temporary crown having an exterior surface that is sized and contoured to substantially replicate corresponding to-be-replaced said natural tooth surfaces that, when said natural tooth is in situ, are surrounded and juxtaposed by adjacent gum tissues;
said temporary crown having a substantially central lumen that is sized and shaped for telescopically receiving therein, and for mechanically registering with said crown interface shaft portion of said scanning abutment for resisting axial rotation of said crown interface shaft portion relative to said temporary crown;
implanting said dental implant;
attaching said scanning abutment to said dental implant; and
attaching said temporary crown to said scanning abutment.

4. The method of claim 3 further comprising the step of digital scanning of said scanning abutment.

5. The method of claim 3 further comprising the step of creating an impression for construction of a permanent restoration, using said scanning abutment as an impression coping.

6. A method for providing temporary, prosthetic teeth and healing promotion structures to a dental implant patient comprising the steps of:
selecting first and second elongate scanning abutments, each configured of a radiopaque, biocompatible material, each of said scanning abutments having:
an implant interface portion configured at a distal scanning abutment end, said implant interface portion being configured in dimension and contouring for mechanical interface in a telescopic engagement with a complimentarily sized and shaped lumen of respective first and second dental implants and for resisting axial rotation relative to said dental implants,
a flange portion of dimensions and contours for nested juxtaposition between respective surfaces of said flange and a proximal orifice of each of respective said dental implants,
a temporary crown interface shaft portion extending from said flange portion and terminating at a proximal scanning abutment end, and
a central lumen passing substantially axially along a central axis;
said temporary crown interface shaft portions of each of said scanning abutments being configured in complimentary dimensions and contouring for, at least in part, mechanical interface in a male-female engagement with a lumen of a temporary crown and for resisting axial rotation relative to said temporary crown, and with said dimensions and contouring of respective said first and second scanning abutments being further physically differentiated relative to each other by the addition or removal of surface projections, protrusions or indentions to one or both of said first and second scanning abutments;
first and second temporary crowns each having an exterior surface that is sized and contoured to substantially replicate surfaces of corresponding to-be-replaced, respective said first and second natural teeth that, when said natural teeth are in situ, are surrounded and juxtaposed by adjacent gum tissues;
said temporary crowns each having a substantially central lumen that are sized and shaped for telescopically receiving therein, and for mechanically registering with said crown interface shaft portions of said first and second scanning abutments for resisting axial rotation of said crown interface shaft portion relative to respective said first and second temporary crowns;
attaching said first and second scanning abutments to respective said first and second dental implants; and
attaching said first and second temporary crowns to respective said first and second scanning abutments.

7. The method of claim 6 further comprising the step of creating an impression for construction of a permanent restoration, using said scanning abutment as an impression coping.

8. The method of claim 6 further comprising the step of digital scanning of said scanning abutment.
